(19) United States
(12) Patent Application Publication
(10) Pub. No.: US 2023/0309550 A1
(43) Pub. Date: Oct. 5, 2023

(54) PIT BLIND FOR WATERFOWL HUNTING

(71) Applicant: Walter Perry Creel, Jena, LA (US)

(72) Inventor: Walter Perry Creel, Jena, LA (US)

(21) Appl. No.: 18/046,284

(22) Filed: Oct. 13, 2022

Related U.S. Application Data
(60) Provisional application No. 63/327,607, filed on Apr. 5, 2022.

(51) Int. Cl. A01M 31/02

(52) U.S. Cl. CPC A01M 31/025

(57) ABSTRACT

A customizable pit blind assembly for waterfowl or other hunting is disclosed. The pit blind includes a number of sections that are detachably connectable with one another. The sections are generally forms as shells with hollow interiors, with the hollow interiors being designed to receive water to selectively sink or raise the pit blind, as needed. Multiple mid-sections can be added to the pit blind to enlarge the overall assembly, thus enabling a larger amount of hunters to be in the pit blind assembly at a single time.

### CROSS-REFERENCE TO RELATED APPLICATION

This application claims the benefit of priority of U.S. provisional application number 63/327,607, filed Apr. 5, 2022, the contents of which are herein incorporated by reference.

### BACKGROUND OF THE INVENTION

The present invention relates to pit blinds and, more particularly, to a custom polyethylene plastic pit blind for waterfowl hunting.

There is currently no ideal way for a hunter to be concealed from waterfowl, such as ducks, from flying in. Consequently, there is a need for a pit blind as detailed herein. An object of the present invention is to provide an eco-friendly, lightweight, adaptable/adjustable and mobile means of concealment for waterfowl hunter(s) while in pursuit of their game.

### SUMMARY OF THE INVENTION

In one aspect of the present invention, a modular blind assembly is disclosed that comprises: a first end section and a second end section oppositely disposed relative to one another; a first mid-section sandwiched between and detachably coupled to the first end section and the second end section, the first mid-section defining a first ballast tank that, in use, receives water; a first gasket that seals between the first end section and the first mid-section; and a second gasket that seals between the second end section and the first mid-section.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in use;

FIG. 2 is a perspective view of the embodiment of the present invention;

FIG. 3 is an exploded view of the embodiment of the present invention, with fasteners not shown for clarity;

FIG. 4 is a section view taken along 4-4 in FIG. 2;

FIG. 5 is a section view of the embodiment of the present invention, showing motion of the top cover 14 and ceiling door 16;

FIG. 6 is a section view taken along 6-6 in FIG. 2; and

FIG. 7 is an alternate configuration of the embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details. For the purpose of clarity, technical material that is known in the technical fields related to the present invention has not been described in detail so that the present invention is not unnecessarily obscured.

Broadly, one embodiment of the present invention is a modular blind assembly. The present invention allows a hunter to stay concealed during duck hunting. In accordance therewith, a blind assembly is provided for waterfowl hunters (single occupancy or multiple hunters) to conceal themselves from waterfowl while in pursuit (hunting) of the game. The present invention claimed here solves the problem of offering a lightweight, eco-friendly product that also offers the ability to adjust the height/depth of the pit blind by pumping water into the main frame holding tanks, also referred to herein as “ballast tanks”, (to submerge or lower the blind) or pumping water out of the main frame ballast tanks (to raise the blind).

The blind assembly may be formed from, for example, high-density polyethylene molded plastic. Its configuration enables additional segments/sections to be selectively added to increase the capacity for additional hunters. Each section adds space for an additional hunter and provides the ability to submerge the hunter into the surface of water to provide concealment for the hunter. These sections may be bolted together, thus providing a customizable setup. The present invention also offers the ability to adjust the height/depth of the pit blind assembly by pumping water in to or out of the ballast tank that is made into the body of the pit blind. The present invention can be utilized on land, or in shallow water hunting situations/conditions. Further, a rubber gasket is custom cut and fitted to be installed between the segments/sections to ensure an impervious seal throughout the whole product.

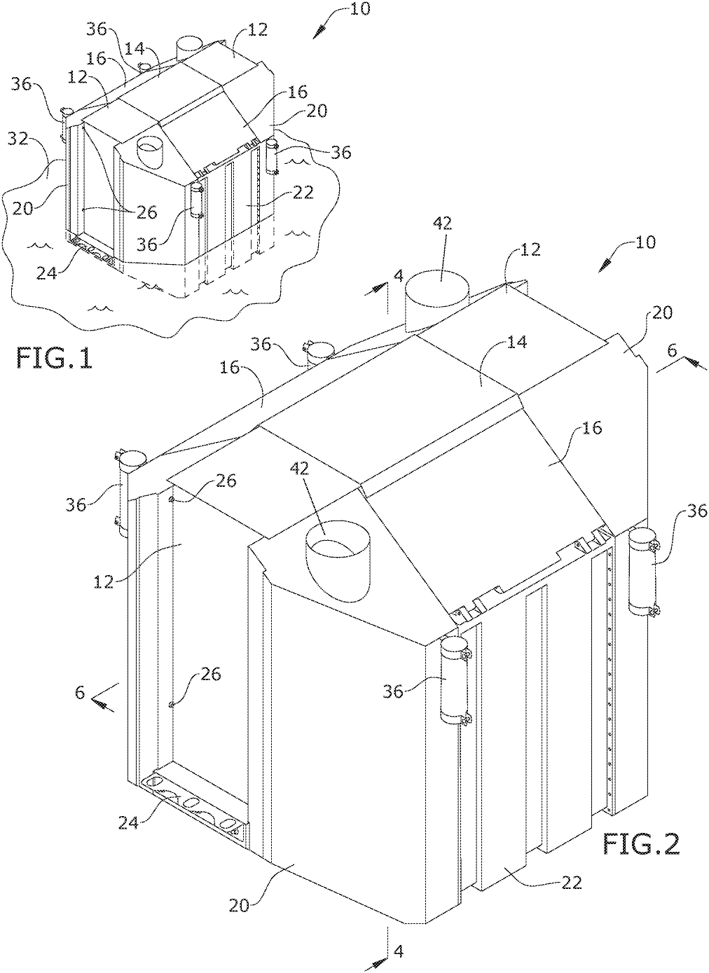

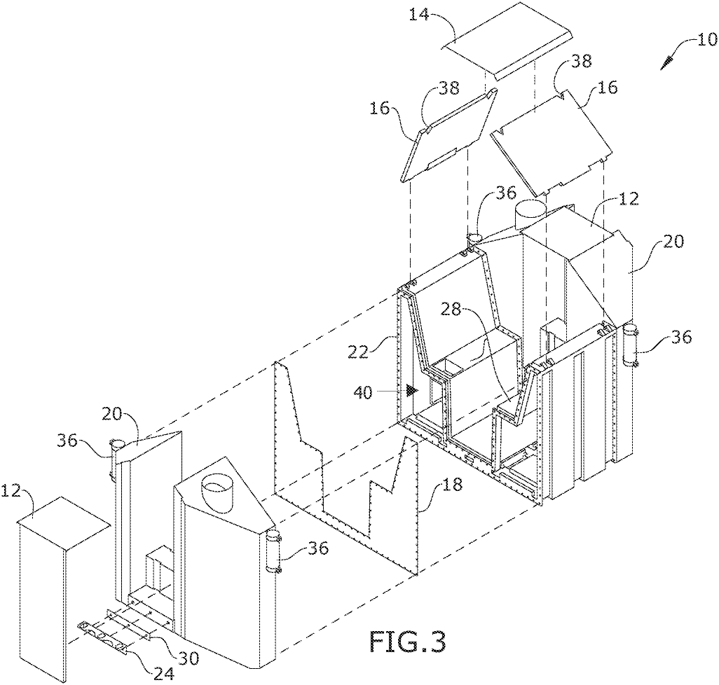

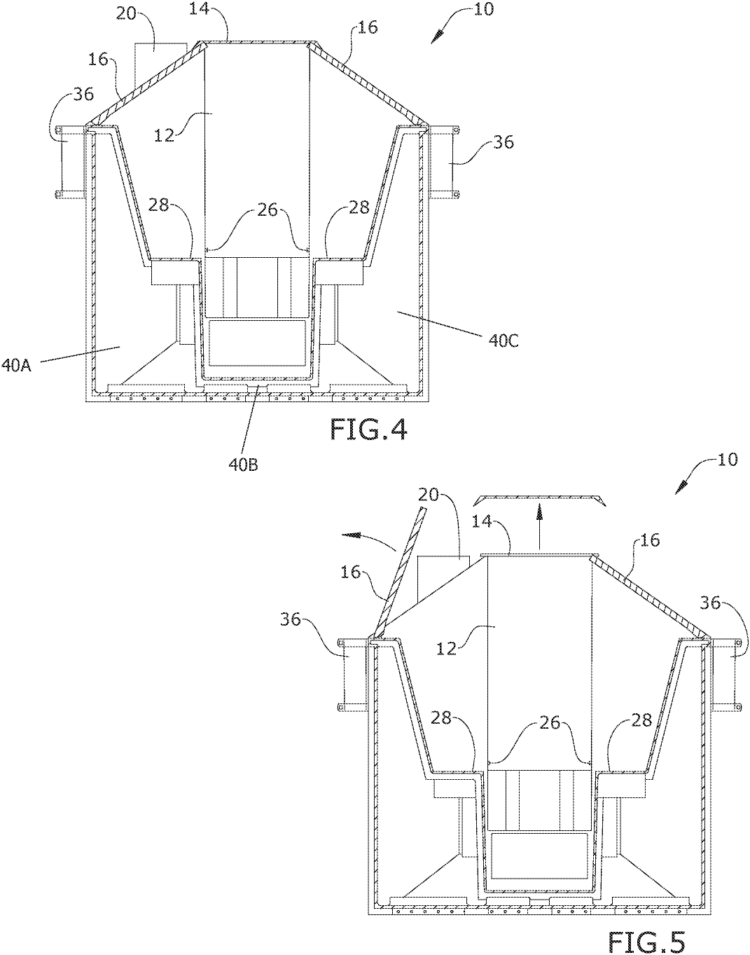

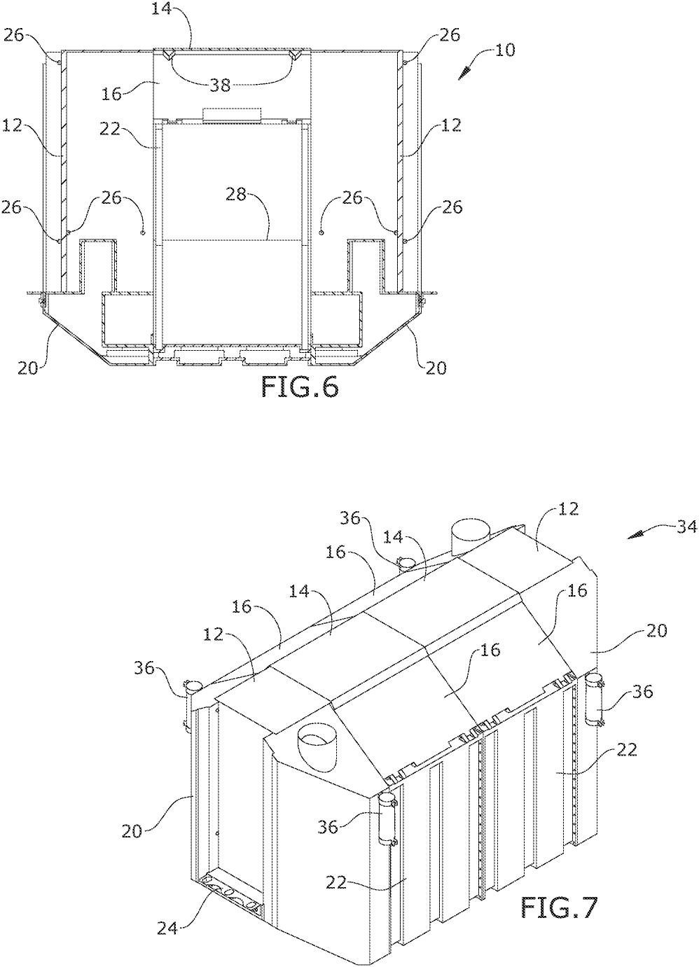

Referring now to FIGS. 1-7, a modular blind assembly 10 is shown. The blind assembly 10 includes doors 12 at terminal end sections 20 of the assembly 10. As shown in FIGS. 3 and 7, one or more mid-sections 22 are provided between these doors end sections 22, with each section provided for a hunter to sit within. Referring to FIG. 3, each mid-section 22 includes a top cover 14, a ceiling door 16, and an interior seat 28. Further, as shown in FIGS. 3-5, the outer profile of each mid-section 22 forms a shell in which a ballast tank 40 is defined. The ballast tank 40 has a left section 40A, a middle section 40B, and a right section 40C, as shown in FIG. 4, which are respectively defined on lateral sides (sections 40A, 40C) and a bottom side (section 40B) of the mid-section 22.

As shown in FIG. 5, the top cover 14 is liftable for selective removal, and the ceiling doors are pivotally mounted to the main body of the mid-section (the portion which includes the seat 28). Cover 14 is used to help secure/enclose the blind when not in use. Cover 14 is designed to be removed when the blind is being used for any activity, e.g., to allow for “shooting space” or opening to view out of the blind for observation. The cover 14 may be provided with rubber bungee-type straps that hold them in place on top of the blind. The ability to totally enclose/secure the blind is important, as it keeps pests and other unwanted wildlife out of the product.

In order for proper operation of the flaps/ceiling doors 16, the cover 14 must be removed. The side flaps/ceiling doors 16 are hinged covers that are used for concealment (while in the UP position, generally shown in FIG. 4) and have the ability to be pushed out of the user’s way, by hand, and swing open (the DOWN position, generally illustrated by the direction of rotation shown in FIG. 5) at just over a 90-degree angle. The side flaps 16 are “shooting flaps” that may be mounted to blind with hinge pins and are used to conceal the hunter/shooter until it is time to shoot, and the flaps 16 may be pushed out of the way (down and out) to allow the hunter to shoot.

The doors 12 are primarily used as ingress/egress points for the users, although they do have a dual purpose. These “L” shaped covers/doors 12 provide a secure/enclosed end piece when the blind is not being used, and also have the ability to be removed from their upright (vertical) position and reinserted sideways (horizontally) into the same opening on the end section 20 to create a platform on which a dog (or another animal of the user) can stand on or hide in. They are not hinged or mounted to the blind 10, but rather “inserted” into position by sliding the door 12 between pins that hold the piece in place.

Further, a gasket 18 is fitted between adjacent sections 22 which creates a waterproof seal therebetween. As FIG. 7 demonstrates, multiple mid-sections 22 can be coupled serially with one another to create a larger overall blind assembly 34 for housing more hunters (in that shown embodiment, two hunters can sit in the blind assembly 34). When coupled, the holding tanks 40, due to the open sides of each mid-section 22, fluid (e.g., water) can flow freely between sections 22 (explained in greater detail below). The end sections 20 also have a similar open side design with a hollow section to achieve the same ends. In other words, these sections 20, 22 are fluidically coupled with one another.

Other components of the blind assembly 10 include toe bars 24, door retaining screws 26, toe bar brackets 30, outer tubes 36, and notches 38 defined in the ceiling doors 16. The tow bars 24, in conjunction with the tow bar plates/washers/brackets 30 provide the user with a means of attaching to, or hooking a tow cable to the completed blind/unit as a whole and “dragging” it into position, or relocate it as desired or needed. The tow bar 24 may be made of stainless steel and include three eyes on the outer plate to hook a cable to. The tow bar plate 30 may be embodied essentially as an oversized washer made from stainless steel and used to help support the weight/pressure placed on the tow bar 24 while the product is being “towed” or relocated.

The door retaining bolts/fasteners 26 may be small rounded head type fasteners that screw into inserts that are molded into the frame of the doorway used for egress/ingress which allows the doors 12 to be mounted either vertically or horizontally by sliding the doors 12 in between the rounded head bolts.

The outer tubes 36 are bolted directly to the body of the blind on each section (End Tanks and Intermediate Tanks) on the outside wall. These tubes 36 can be used to help stabilize the assembly 10, when being used as a “floater” in shallow water areas, by driving a two inch diameter piece of pipe (whatever length needed) through the tube 36 and into the ground so that the blind can rise and fall with the water level but still maintain its location without drifting.

The notches 38, as shown, cut into the edge of panels 16 are for helping to secure shotguns (when the panels are folded outwardly). The user can place the stock of the gun on the floor of the blind and lean the barrel of the shotgun into the notch 38. An alternate positioning would be to lay the gun “at rest” horizontally across the top of panel 16 with the barrel/forearm in one notch and the stock in the other notch.

In use, and as shown in FIG. 1, the blind assembly 10 can sit, partially submerged, in a body of water 32. The fitted gaskets 18 prevent the ingress of water between adjacent sections 20, 22 (depending upon the configuration of the overall assembly, e.g., a single mid-section 22 between end sections 20 or multiple mid-sections 22 between the end sections 20), with the holding/ballast tank(s) 40 providing adjustable height out of the water 32. This is achieved by pumping water in and out of the holding tank(s) 40 through a conduit 42. As shown, for example, in FIG. 2, the conduits 42 may be a wide opening (e.g., 6 inches in diameter) defined at a top end of the end sections 20. As those with skill in the art will appreciate, the conduits 42 may be defined in any appropriate location (e.g., defined in one of the mid-sections 22). Adding more water results in the blind assembly 10 sinking further into the water, with pumping water out of the tank(s) 40 providing the opposite effect. This results in better and customizable concealment for the hunter(s) by creating a low profile for the overall assembly 10.

As those with skill in the art will appreciate, the present invention may be formed in various ways. In certain embodiments, roto casting may be used. A roto-mold may be made for each component type (e.g., each section). The polyethylene material may be heated and inserted into the roto-mold to make the shape of the desired component for each unit.

Once produced, to put the blind assembly 10/34, which may occur as follows. First, determine how many hunters/occupants will need to be accommodated for at the location where the blind will be installed. Next, the appropriate number of mid-sections 22 is selected based on the number of hunters that need to be accommodated. Next, the mid-sections 22 and two end sections 20 are bolted together to create the desired size blind assembly 10/34. It will be appreciated that the assembly 10/34 can be assembled either on site (in the field where it will be used) or pre-assembled in a “shop” by the user, then transported to the desired location where it will be installed. The blind assembly 10/34 is then transported to the field/desired location. The blind assembly 10/34 is sunk into place by pumping water into the main body (the mid-sections 22 that are coupled together) of the assembly 10/34. Specifically, water is pumped into the holding tank(s) 40 of the main body. This step may be achieved by utilizing two pumps (e.g., a 12-volt bilge pumps (750 GPH)) and flex hoses that are provided with the blind kit so that water can be pumped into the hollow body of the blind section 22 through the large 8″ diameter openings in the top of the end tanks 20. As discussed above, the open design of the end tanks 20 and the intermediate tanks 22 allows for the water to flow freely from end to end and side to side in all of the sections 20, 22 that are bolted together and sealed with gaskets 18. To remove the water pumped into the ballast tank 40, just drop the pumps into the large (e.g., 8-inch) diameter holes in the top of the end tanks 20 and run the exhaust hose out of the cavity of the blind 10/34 and into the area surrounding the blind location. This will allow the blind 10/34 to rise and float or stay partially submerged, whatever position is desired. The blind 10/34 does have internal storage areas/battery compartments for the 12-volt batteries required to perform this task, however, the batteries may be provided separately. Once in place, the assembly 10/34 can be stabilized (if necessary) via external posts driven down into the ground through holders 36 (made into the body of the blind) that are located on the outside wall of the blind assembly 10/34. Once in place, the blind assembly 10/34 can be covered with camouflage (either branded camouflage or native grasses/weeds that are indigenous to the area) and it is ready for use.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. The term “substantially” shall be interpreted to mean completely and/or nearly completely. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

What is claimed is:

1. A modular blind assembly comprising:
a first end section and a second end section oppositely disposed relative to one another;
a first mid-section sandwiched between and detachably coupled to the first end section and the second end section, the first mid-section defining a first ballast tank that, in use, receives water;
a first gasket that seals between the first end section and the first mid-section; and
a second gasket that seals between the second end section and the first mid-section.

2. The modular blind assembly of claim 1, wherein the first ballast tank is open at lateral ends thereof.

3. The modular blind assembly of claim 2, wherein the first ballast tank comprises a first ballast tank section defined proximal a first lateral side of the first mid-section, a second ballast tank section defined proximal a bottom of the first mid-section, and a third ballast tank section proximal a second lateral side of the first mid-section.

4. The modular blind assembly of claim 1, wherein the first end section and the second end section each define a hollow section that combines with the first ballast tank to, in use, receive the water.

5. The modular blind assembly of claim 1, further comprising a first conduit for the water to pass through to enter and exit the first ballast tank.

6. The modular blind assembly of claim 5, wherein the first conduit is positioned on the first end section.

7. The modular blind assembly of claim 5, wherein the first conduit is positioned on the first mid-section.

8. The modular blind assembly of claim 1, further comprising:
a second mid-section sandwiched between the first end section and the first mid-section, the second-mid-section defining a second ballast tank that combines with the first ballast tank to, in use, receive the water.

9. The modular blind assembly of claim 7, wherein the second ballast tank comprises a first ballast tank section defined proximal a second lateral side of the second mid-section, a second ballast tank section defined proximal a bottom of the second mid-section, and a third ballast tank section proximal a second lateral side of the second mid-section.

10. The modular blind assembly of claim 7, further comprising:
a conduit for the water to pass through to enter and exit the first ballast tank and the second ballast tank.
